(19) United States
(12) Patent Application Publication
(10) Pub. No.: US 2013/0072049 A1
(43) Pub. Date: Mar. 21, 2013

(54) CONNECTOR ASSEMBLY, MALE CONNECTOR, AND MANUFACTURING METHOD FOR MALE CONNECTOR

(71) Applicant: Panasonic Corporation, Osaka (JP)

(72) Inventors: Daisuke SATO, Mie (JP); Mitsuru IIDA, Mie (JP); Hiroshi IWANO, Osaka (JP); Tadahiro YAMAJI, Osaka (JP)

(73) Assignee: PANASONIC CORPORATION, Osaka (JP)

(21) Appl. No.: 13/624,526

(22) Filed: Sep. 21, 2012

(30) Foreign Application Priority Data
Sep. 21, 2011 (JP) 2011-206079

(51) Int. Cl. H01R 13/64; H01R 43/20

(52) U.S. Cl. 439/378; 29/876

(57) ABSTRACT

In a connector assembly 1, male and female terminals 13 and 23 are positioned by inserting guide protrusions 15 into hole portions 25. Each of the guide protrusions 15 includes: a positioning portion 15a positioning male terminals 13 and female terminals 23; and a temporary positioning portion 15b which is smaller in diameter than the positioning portion 15a and is provided on the positioning portion 15a. The temporary positioning portion 15b is inserted through the hole portions 25 for temporary positioning of the male and female connectors 10 and 20 before the positioning portion 15a is inserted through the hole portions 25.

### CROSS REFERENCE TO RELATED APPLICATIONS

This application is based upon and claims the benefit of priority from prior Japanese Patent Application P2011-206079 filed on Sep. 21, 2011; the entire contents of which are incorporated by reference herein.

### BACKGROUND OF THE INVENTION

The present invention relates to a connector assembly, a male connector, and a method of manufacturing the male connector.

As shown in Japanese Patent Laid-open Publication No. 2009-277534, one of known connector assemblies includes a columnar protrusion (guide protrusion) and a ring (hole) for positioning which are respectively provided for facing surfaces of a male connector having a male terminal and a female connector having a female terminal.

### SUMMARY OF THE INVENTION

In the aforementioned conventional connector assembly, by inserting and fitting the columnar protrusion into the ring, the male terminal and the female terminal are precisely positioned, and the male connector having the male terminal and the female connector having the female terminal can be joined to each other.

However, in such a configuration that the columnar protrusion is fit into the ring from the beginning in the process of assembling the connector assembly, the terminals are difficult to connect because of tight insertion of the columnar protrusion into the ring. The assembly performance thereof could be therefore degraded.

Accordingly, an object of the present invention is to provide a connector assembly and a male connector which are capable of improving the workability in assembling the male and female connectors and a method of manufacturing the male connector.

A first aspect of the present invention is a connector assembly, including: a male connector including a male terminal; and a female connector including a female terminal, the male and female connectors being joined to each other with the male and female terminals being brought into contact. In the connector assembly, a guide protrusion protruding higher than the male terminal is provided on one of facing surfaces of the male and female connectors, a hole portion into which the guide protrusion is inserted to position the male and female terminals is provided for the other facing surface, the guide protrusion includes: a positioning portion positioning the male and female terminals; and a temporary positioning portion which is provided on the positioning portion and has a diameter smaller than that of the positioning portion, and the temporary positioning portion being inserted into the hole portion for temporary positioning of the male and female connectors before the positioning portion is inserted into the hole portion.

A second aspect of the present invention is that the hole portion has a function of being introduced to a position where the positioning portion is inserted into the hole portion and performing temporary positioning of the male and female connectors when the temporary positioning portion is inserted into the hole portion.

A third aspect of the present invention is that the male terminal is formed such that a diameter of a tip end portion thereof is made smaller as a distance from a base substrate of the male connector increases.

A fourth aspect of the present invention is that the male terminal has a mushroom shape.

A fifth aspect of the present invention is a male connector used in the aforementioned connector assembly.

A sixth aspect of the present invention is a method of manufacturing a male connector which includes: a male terminal; and a guide protrusion protruding higher than the male terminal and including a positioning portion and a temporary positioning portion, the temporary positioning portion being formed on the positioning portion and having a smaller diameter than the positioning portion. The method includes the steps of: forming a first dry film resist layer on one of surfaces of a circuit substrate; exposing and developing part of the first dry film resist layer to form a hole for forming the male terminal and a hole for forming the positioning portion of the guide protrusion; forming a second dry film resist film to cover top part of the hole for forming the positioning portion; exposing and developing part of the second dry film resist layer to form a hole for forming the temporary positioning portion of the guide protrusion and thereby forming a hole for forming the guide protrusion which is composed of the hole for forming the temporary positioning portion and the hole for forming the positioning portion; and plating the hole for forming the male terminal and the hole for forming the guide protrusion to form the male terminal and guide protrusion.

### BRIEF DESCRIPTION OF THE DRAWINGS

FIG. 1 is a perspective view of a connector assembly according to an embodiment of the present invention, showing the rear side of a male connector and the front side of a female connector.

FIG. 2 is a perspective view of the connector assembly according to the embodiment of the present invention, showing the front side of the male connector and the rear side of the female connector.

FIG. 3 is a side view showing an assembly state of the male and female connectors shown in FIGS. 1 and 2.

FIG. 4 is a side view showing the connector assembly in which the male and female connectors, which are shown in FIG. 3, are joined to each other.

FIG. 5 is a cross-sectional view showing an inserted guide protrusion shown in FIG. 4.

FIG. 6 is a cross-sectional view showing an inserted male terminal shown in FIG. 4.

FIG. 7 is an enlarged view of the hole portion shown in FIG. 1.

FIGS. 8A to 8J are views for sequentially explaining a manufacturing process of the male connector shown in FIG. 2.

FIGS. 9A and 9B are a plan view and a side view showing the guide protrusion of FIG. 4, respectively.

FIGS. 10A to 10C are views showing modifications of the planer shape of the guide protrusion shown in FIG. 4, FIG. 10A to 10C being plan views of guide protrusions according to first to third modifications, respectively.

FIGS. 11A and 11B are views showing modifications of the side shape of the guide protrusion shown in FIG. 4, FIGS. 11A and 11B being side views of guide protrusions according to first and second modifications, respectively.

FIGS. 12A to 12C are plan views showing shapes of hole portions suitable for the planar shapes of the guide protrusions shown in FIGS. 10A to 10C, respectively.

FIG. 13A to 13C are plan views showing modifications of shapes of hole portions suitable for the planar shapes of the guide protrusions shown in FIGS. 10A to 10C, respectively.

FIG. 14 is a perspective view showing a modification of the female connector shown in FIG. 1.

FIG. 15 is a perspective view showing a modification of the male connector shown in FIG. 1.

### DETAILED DESCRIPTION OF THE PREFERRED EMBODIMENTS

Hereinafter, a description is given of an embodiment of the present invention in detail with reference to the drawings.

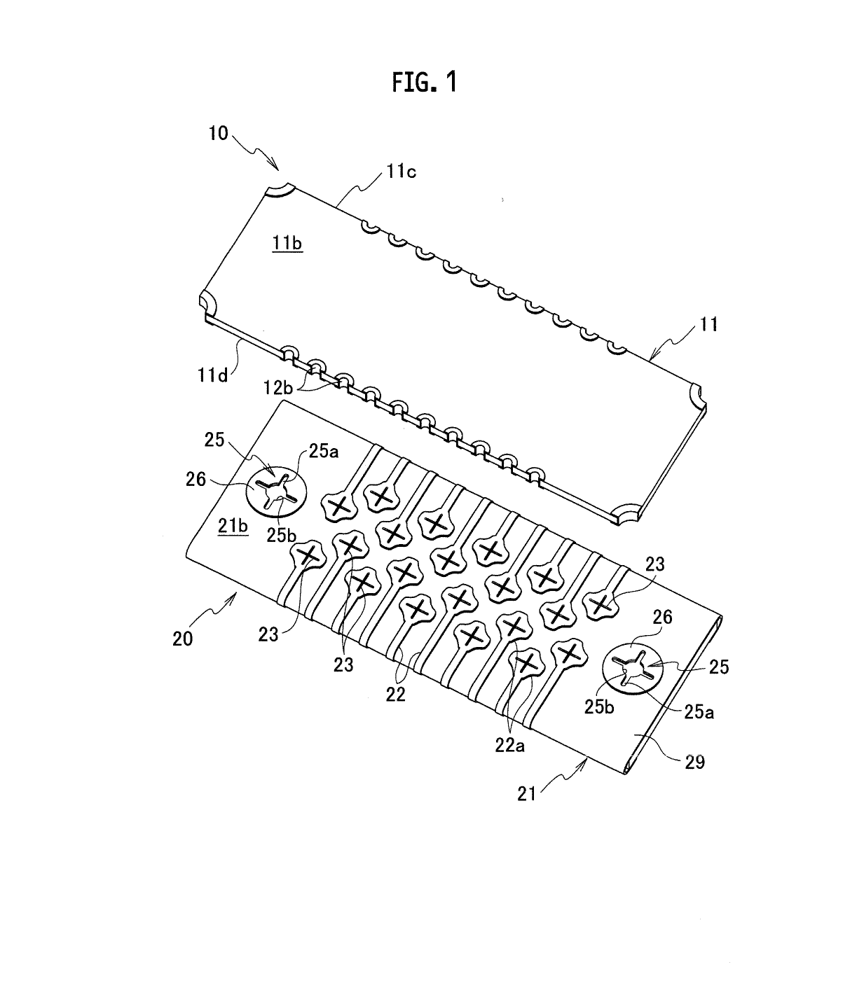

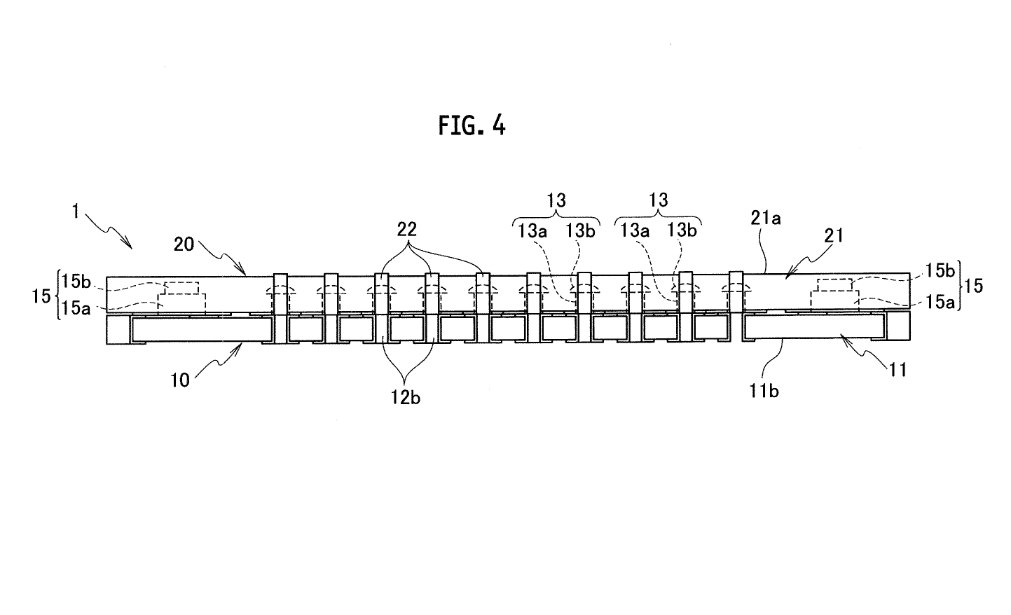

FIGS. 1 to 8J are views showing an embodiment of a connector assembly according to the present invention. The connector assembly 1 shown in FIG. 4 is formed by joining a male connector 10 and a female connector 20, which are shown in FIGS. 1 to 3.

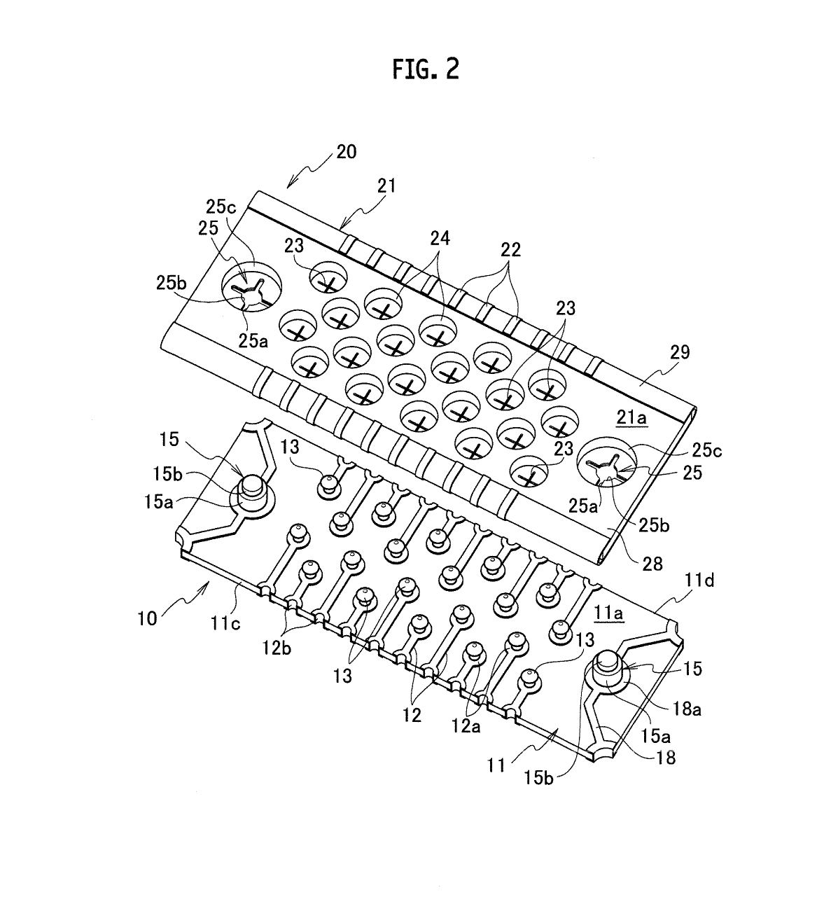

As shown in FIGS. 1 and 2, the female connector 20 is formed as a FPC substrate by patterning plural conductor lines 22 on a rear surface 21b of a base substrate 21, which includes an insulating film 29 made of polyimide resin or glass epoxy resin. At an end of each of the conductor lines 22, a cross-shaped slit 23 as a female terminal is provided.

The cross-shaped slits 23 is concentrically formed at the center of a wide cross-shaped pad 22a, which is provided at an end of each conductor line 22. The cross-shaped slit 23 penetrates the cross-shaped pad 22a and base substrate 21. To be specific, in this embodiment, a substrate body 28 (see FIG. 2), which is made of synthetic resin or the like, is provided with plural through-holes 24. The cross-shaped slits 23 are formed so as to communicate with the respective through-holes 24, and thereby the cross-shaped slits 23 penetrate the cross-shaped pads 22a and base substrate 21.

The plural cross-shaped slits 23 are orderly arranged in the base substrate 21 in a matrix fashion. In this embodiment, there are 20 cross-shaped slits 23 in total, which are arranged in five rows in the longitudinal direction of the base substrate 21 and four columns in the width direction. In this arrangement, the columns adjacent to each other in the width direction are shifted from each other in the longitudinal direction.

As shown in FIGS. 1 and 2, the male connector 10 includes a rectangular base substrate 11 with four corners chamfered. The base substrate 11 is made of an insulating material such as synthetic resin. On a surface 11a of the base substrate 11, male terminals 13 are protruded.

The male terminals 13 are provided for respective ring pads 12a, each of which is provided at an end of a conductor line 12. The conductor lines 12 extend from both widthwise edges 11c and 11d of the base substrate 11 widthwise inward. The male terminals 13 are arranged at 20 places in total corresponding to the positions of the respective cross-shaped slits 23.

The male terminals 13 are made of a conductive material such as metal or conductive resin. Each of the male terminals 13 includes a neck portion 13a which has a columnar shape of such a diameter that the neck portion 13a can be inserted (pressed) into the cross-shaped slit 23 while deforming the peripheral part of the cross-shaped slit 23. In this event, for the purpose of opening the cross-shaped slit 23 equally in the circumferential direction, it is preferable that the neck portion 13a has a columnar shape with a circular cross-section. However, the cross-sectional shape thereof is not limited to the circular shape and may be a not-circular shape such as an elliptical shape or a polygonal shape.

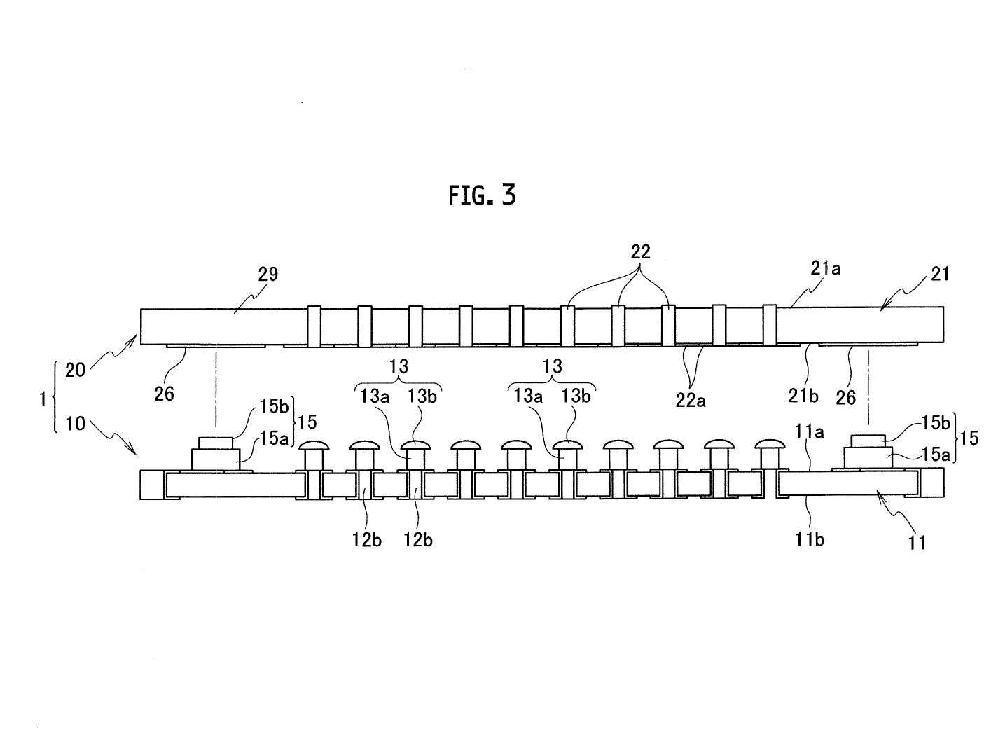

As shown in FIG. 3, a head portion 13b larger in diameter than the neck portion 13a is formed at the top of each male terminal 13. The head portion 13b has a spherical top surface like a mushroom cap. To be specific, in each male terminal 13, the diameter of the head portion (tip end portion) 13b is made smaller as a distance from the base substrate 11 of the male connector 10 increases. Such male terminals 13 are thus formed as so-called mushroom bumps.

The other ends of the conductor lines 12 connected to the male terminals 13 are exposed in the both widthwise edges 11c and 11d of the base substrate 11, and exposed surface 12b of each conductor line 12 is a contact with another circuit substrate or electronic part, which is not shown.

Herein, in this embodiment, guide protrusions 15 protruding higher than the aforementioned male terminals 13 are provided on the surface 11a of the base substrate 11 of the male connector 10, which is one of the facing surfaces of the male and female connectors 10 and 20. The guide protrusions 15 are made of metal or high-rigidity synthetic resin. As shown in FIG. 2, in this embodiment, there are two guide protrusions 15 in total which are located on each side of the base substrate 11 in the longitudinal direction.

Each of the guide protrusions 15 includes a neck portion 15a, which has a columnar shape with such a diameter that the neck portion 15a can be inserted (pressed) into a hole portion 25 while deforming the edge of the hole portion 25. The neck portions 15a function as a positioning unit which positions the male terminals 13 and the cross-shaped slits (female terminals) 23.

As shown in FIG. 3, a head portion 15b a little smaller in diameter than the neck portion 15a is formed in the top (on the neck portion 15a) of each guide protrusion 15. This head portion 15b is also columnar. The head portion 15b is provided on the neck portion (positioning unit) 15a and corresponds to a temporary positioning unit which is inserted into the hole portion 25 for temporary positioning of the male and female connectors 10 and 20 before the neck portion (positioning unit) 15a is inserted into the same.

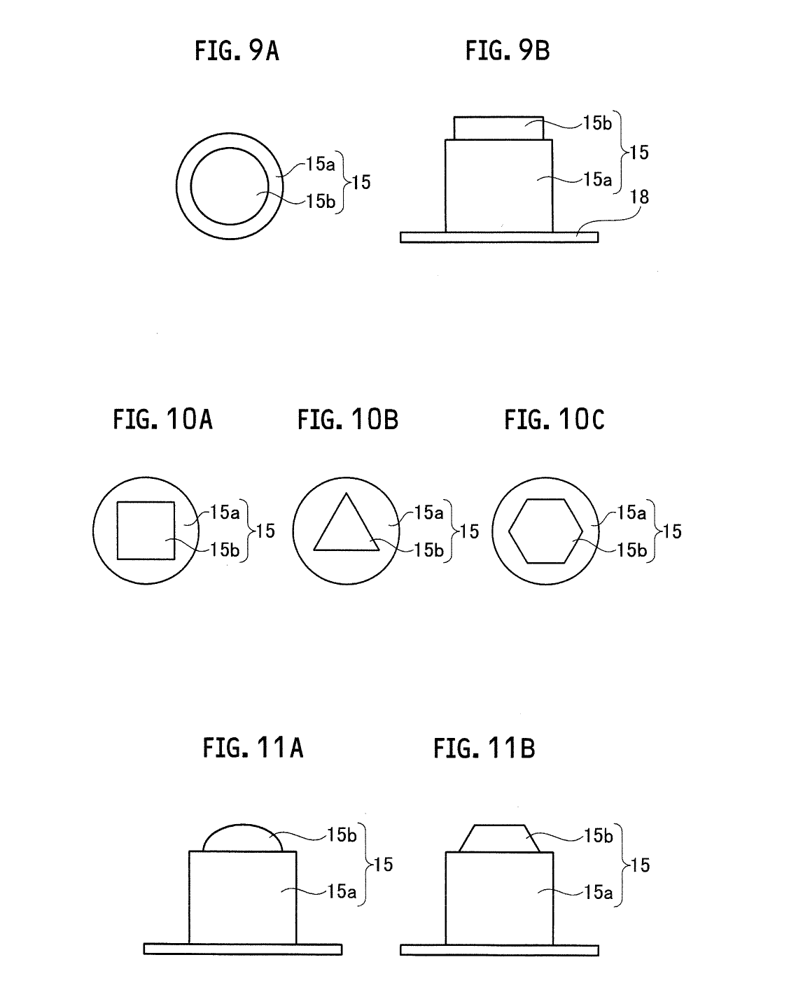

As shown in FIGS. 9A and 9B, the guide protrusion 15 has such a shape that the head portion 15b, that has a columnar shape smaller in diameter than the columnar neck portion 15a, is formed on the neck portion 15a. The shape of the head portion 15b is not limited to the columnar shape and may be varied.

For example, the head portion 15b may have a square plan view as shown in FIG. 10A, a triangular plan view as shown in FIG. 10B, or a hexagonal plan view as shown in FIG. 10C. Alternatively, the head portion 15b may have an arcular side view as shown in FIG. 11A or a trapezoidal side view as shown in FIG. 11B. The shape of the head portion 15b is not limited to the columnar shape and may be varied.

While the guide protrusions 15 are provided for the male connector 10, the hole portions 25, through which the guide protrusions 15 are inserted, are provided for the rear surface 21b of the female connector 20, which is the other one of the facing surfaces of the male and female connectors 10 and 20. The hole portions 25 are provided corresponding to the positions where the guide protrusions 15 are protruded and are located on each side of the base substrate 21 in the longitudinal direction, that is, at two places in total, as shown in FIG. 2.

As shown in FIG. 1, each of the hole portions 25 is composed of: a substantially cross-shaped slit 25a, which is formed in the rear surface 21b of the base substrate 21; and an insertion hole 25c, which communicates with the slit 25a and is larger in diameter than the guide protrusions 15. In other words, the hole portions 25 are large enough to allow the guide protrusions 15 to slightly move. In this embodiment, the two insertion holes 25c penetrate the substrate body 28 in a similar manner to the aforementioned cross-shaped slits 23 as the female terminals. The substantially cross-shaped slits 25a are provided in the insulating film 29 and a ring pad portion 26 so as to communicate with the respective insertion holes 25c to form the hole portions 25.

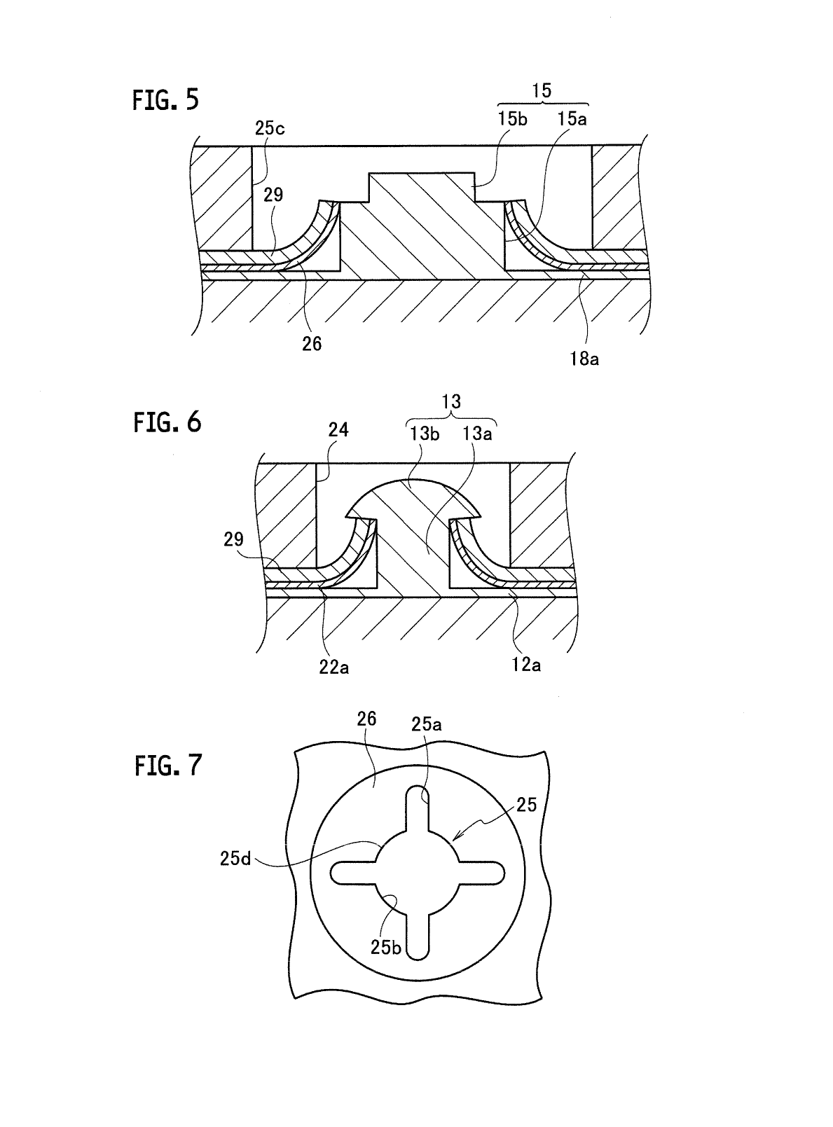

In this embodiment, the substantially cross-shaped slit 25a of each hole portion 25 is provided with a ring-shaped opening 25b concentrically removed from the center of the slit 25a. In the hole portion 25, elastic pieces 25d, which are elastically deformable, are formed. The elastic pieces 25d are protruded from the circumferential edge of the insertion hole 25c toward the center. The ring-shaped opening 25b has a width smaller than the diameter of the head portions 15b of the guide protrusions 15. The guide protrusions 15 can be therefore prevented from being detached as shown in FIG. 5. Moreover, even if the guide protrusion 15 is inserted away from the center of the slit 25a, the neck portion 15a can be guided to the center of the slit 25a by elastic force of the peripheral part of the slit 25a (elastic pieces 25d). Accordingly, it is possible to increase the accuracy of the relative positions of the guide protrusions 15 and the slits 25a.

By providing the elastic pieces 25b for the hole portions 25 in such a manner, the hole portions 25 have a function of performing temporary positioning of the male and female connectors 10 and 20 and being introduced to the positions where the neck portions 15a are inserted into the hole portions 25 when the head portions 15b are inserted into the hole portions 25.

The ring-shaped opening 25b may have a width a little larger than the diameter of the head portions 15b of the guide protrusions 15 and smaller than the diameter of the neck portion 15a.

In other words, the ring-shape opening 25b may be configured so that the head portion 15b is inserted through the ring-shape opening 25b in such a manner that the elastic pieces 25d does not come into contact with the side surface of the head portion 15b. The elastic pieces 25d are brought into contact with the side surface of the neck portion 15a. Accordingly, when the neck portions 15a are inserted in the ring-shaped openings 25b, the ring-shaped openings 25b can position the male terminals 13 and cross-shaped slits (female terminals) 23.

In such a manner, temporary positioning can be implemented when the head portions 15a are inserted into the hole portions 25. Even in such a case, the elastic pieces 25d can introduce the hole portions 25 to the positions where the neck portions 15a are inserted into the hole portions 25. However, the introducing function can be more exerted if the ring-shaped openings 25b have a width smaller than the diameter of the head portions 15b of the guide protrusions 15.

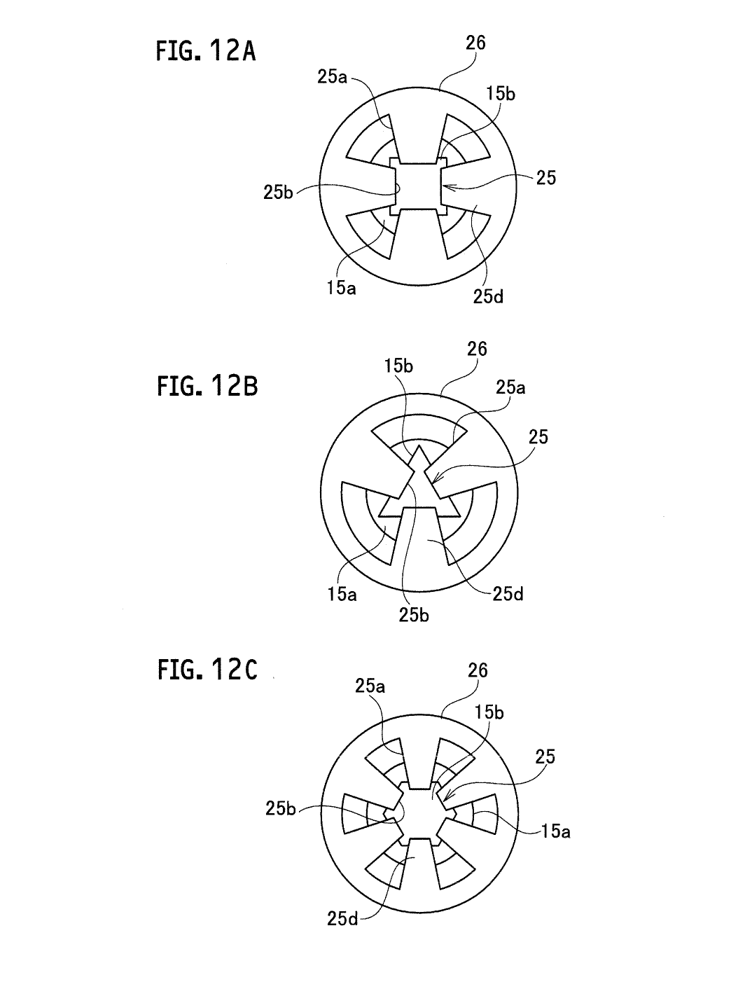

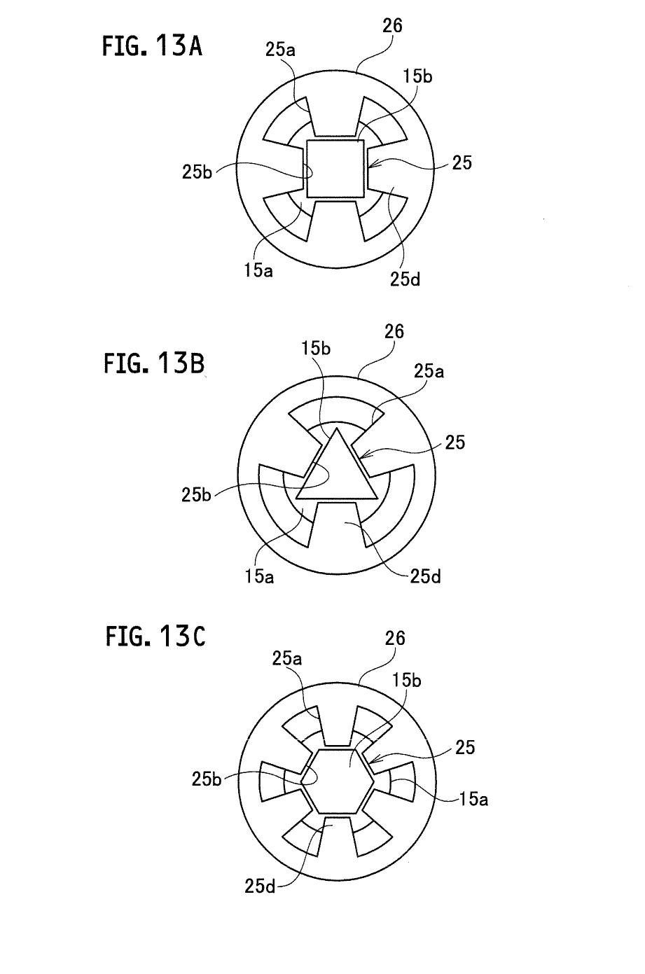

The shape of the hole portions 25 can be varied. It is especially preferable that the hole portions 25 have a more appropriate shape according to the shape of the head portions. If, as shown in FIG. 10A, the shape of the head portions has a rectangular plan view, for example, it is preferable that the hole portions 25 are formed so that the elastic pieces 25d correspond to the respective sides of each head portion 15b when the head portion is in the hole portion 25 (see FIG. 12A or 13A). The same goes for the cases of the triangular shape of FIG. 10B and the hexagonal shape of FIG. 10C (see FIG. 12B or 13B and FIG. 12C or 13C).

In this event, the opening 25b may be formed so that the elastic pieces 25d overlap the head portion 15b in a plan view. The elastic pieces 25d therefore come into contact with the sides of the head portion 15b when the head portion 15b is inserted into the hole portion 25 as shown in FIGS. 12A to 12C. Accordingly, the hole portion 25 can have a similar function to that in the case where the ring-shaped openings 25b have widths smaller than the diameters of the head portions 15b of the guide protrusions 15.

Moreover, the opening 25b may be formed so that the elastic pieces 25d overlap the neck portion 15a but do not overlap the head portion 15b in a plan view. As shown in FIGS. 13A to 13C, therefore, the head portion 15b can be inserted into the opening portions 25b in such a manner that the elastic pieces 25d do not come into contact with the side surface of the head portion 15b. Accordingly, such hole portion 25 can have a similar function to the case where the ring-shaped opening 25b has a width larger than the diameter of the head portions 15b of the guide protrusions 15.

As described above, according to the connector assembly 1 of the embodiment, when the head portions 15b of the guide protrusions 15 are inserted into the hole portions 25, the male terminals 13 and the cross-shaped slits 23 as the female terminals are roughly aligned at first.

In the connector assembly 1, in which the male terminals 13 and the cross-shaped slits 23 are already roughly aligned by the head portions 15b of the guide protrusions 15, when the neck portions 15a are subsequently inserted into the hole portions 25, the male terminals 13 and cross-shaped slits 23 can be accurately positioned.

In such a manner, the connector assembly 1 of this embodiment has a two-step positioning structure in which the male and female terminals are positioned by the neck portions 15a and then the head portions 15b of the guide protrusions 15, which are protruded on the surface 11a side of the male connector 10.

In the thus-configured connector assembly 1, the front surface 11a of the male connector 10 and the rear surface 21b of the female connector 20 are caused to face each other so that the guide protrusions 15 are positioned corresponding to the hole portions 25. By pressing the female connector 20 against the male connector 10 in such a state, the head portions 15b of the guide protrusions 15 are inserted into the hole portions 25, and then the neck portions 15a are inserted into the hole portions 25. In this event, the head portions 15b of the guide protrusions 15 perform rough alignment. Even if the head portions 15b of the guide protrusions 15 are inserted away from the centers of the slits 25a, the head portions 15a of, the guide protrusions 15 are guided to the centers of the slits 25a by elastic force of the peripheral edges of the slits 25a. The neck portions 15a of the guide protrusions 15 guided to the accurate positions can be thereby inserted into the hole portions 25. According to the connector assembly 1 of this embodiment, therefore, the workability in joining the male and female connectors 10 and 20 can be considerably improved.

By joining the male and female connectors 10 and 20 (fitting the neck portions 15a of the guide protrusions 15 into the hole portions 25), as shown in FIG. 6, the male terminals 13 are fit to (brought into contact with) the cross-shaped slits 23 as the female terminals for conduction, thus electrically connecting the male and female connectors 10 and 20. In this event, for the male terminals 13 are formed as so-called mushroom bumps, the head portions (top portions) 13b prevent the male terminals 13 from being detached.

In a state where the male and female connectors 10 and 20 are joined to each other as shown in FIG. 4, the guide protrusions 15 and male terminals 13 are respectively accommodated in the insertion holes 25c and through-holes 24 without protruding from the base substrate 21. Moreover, as shown in FIG. 2, the guide protrusions 15 of this embodiment are protruded on the ring-shaped pads 18a of conductor lines 18 connected to respective corners of the base substrate 11.

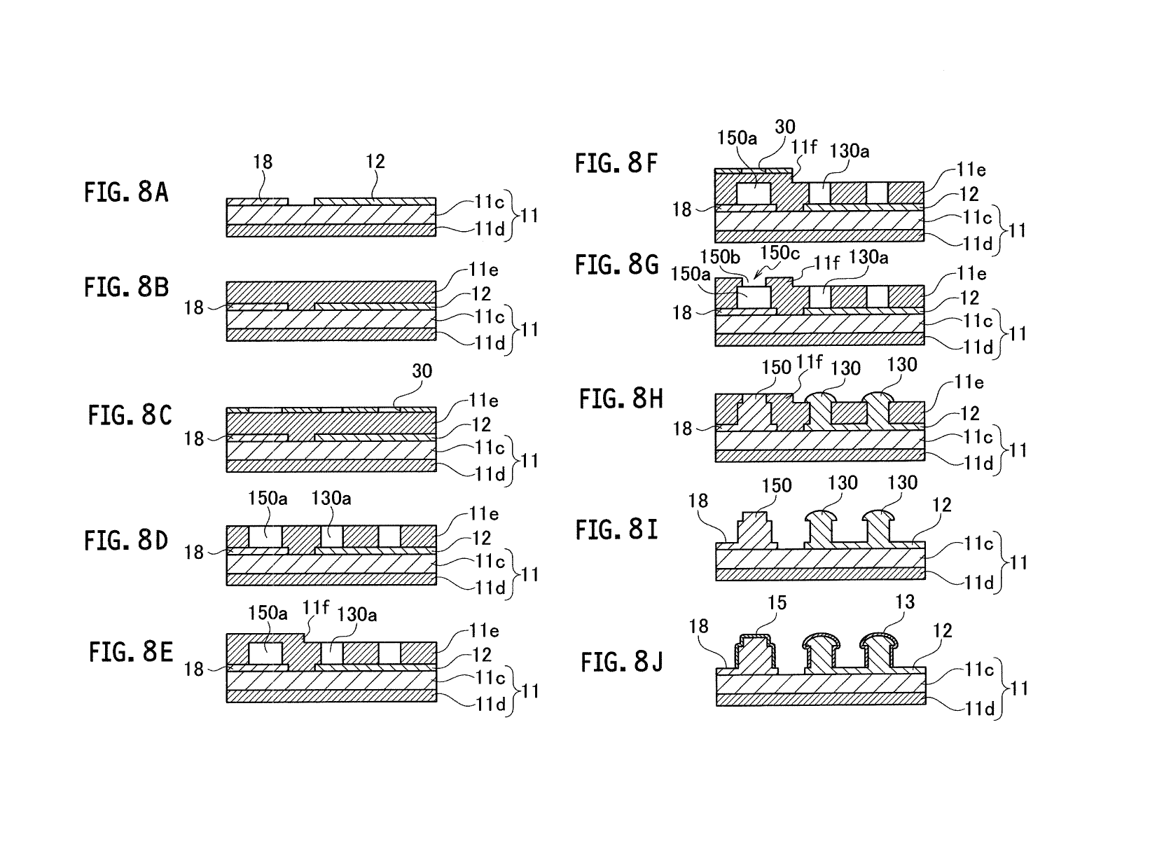

A description is given of a process to manufacture the male connector 10 with reference to FIGS. 8A to 8J.

First, as shown in FIG. 8A, a DF (dry film resist) laminate layer 11d is laminated on the rear surface of the substrate 11c to form the base substrate 11. The DF laminate layer lid has a thickness of 75 μm. The conductor lines 12 and conductor lines 18 are patterned in the surface of the substrate 11c, thus forming a circuit substrate.

Next, as shown in FIG. 8B, on the surface of the substrate 11 (one side of the circuit substrate), a DF laminate layer (first dry film resist layer) lie is formed. The DF laminate layer (first dry film resist layer) lie has a thickness of 225 μm.

Next, as shown in FIG. 8c, resist 30 is applied to the surface of the DF laminate layer (first dry film resist film) lie, which is then partially exposed and developed. As shown in FIG. 8D, then, holes 130a for forming male terminals and holes 150a for forming positioning portions of the guide protrusions 15 are formed.

Next, as shown in FIG. 8E, a DF laminate layer (a second dry film resist film) 11f is formed so as to cover the tops of the holes 150a for forming the positioning portions. The DF laminate layer 11f has a thickness of 75 μm.

As shown in FIG. 8F, resist 30 is applied to the surface of the DF laminate layer (second dry film resist layer) 11f, which is then partially exposed and developed. As shown in FIG. 8G, then, holes 150b for forming the temporary positioning portions of the guide protrusions 15 are formed. The holes 150b for forming the temporary positioning portions and the portions 150a for forming the positioning portions constitute holes 150c for forming guide protrusions.

Thereafter, publicly known treatments such as plasma processing, acidic degreasing, soft etching, and sulfuric treatment are performed. Such treatment can facilitate plate processing later described.

The holes 130a for forming male terminals and holes 150c for guide protrusions are plated to form the male terminals 13 and guide protrusions 15.

In this embodiment, as shown in FIG. 8H, first, the holes 130a for forming male terminals and holes 150c for forming guide protrusions are Cu-plated to form male terminal bodies 130 and guide protrusion bodies 150, respectively.

In this event, the guide protrusion bodies 150 are made higher than the male terminal bodies 130. In this embodiment, the height of the neck portions of the guide protrusion bodies 150 is made substantially equal to the height of the neck portions of the male terminal bodies 130, and the height of the head portions of the male terminal bodies 130 is lower than the height of the head portions of the guide protrusion bodies 150.

As shown in FIG. 8I, the DF laminate layer is then peeled off, and as shown in FIG. 8J, the surfaces of the male terminal bodies 130 and guide protrusion bodies 150 are coated with a conductive material such as Ni or Au to form the male terminals 13 and the guide protrusions 15, which are protruded higher than the male terminals 13.

Thereafter, dicing is performed to form the male connector 10 including; the male terminals 13; and the guide protrusions 15, each of which is protruded higher than the male terminals 13 and has the positioning portion 15a and the head portion (temporary positioning portion) 15b that is smaller in diameter than the neck portion (positioning portion) 15a and is formed on the neck portion (positioning portion) 15a.

As described above, in this embodiment, the head portion (temporary positioning portion) 15b smaller in diameter than the neck portion (positioning portion) 15a is provided on the neck portion (positioning portion) 15a. The male connector 10 and female connector 20 are temporarily positioned by inserting the head portions (positioning portions) 15b into the hole portions 25 before the neck portions (positioning portions) 15a are inserted into the same. Accordingly, by previously inserting the head portions (temporary positioning portions) 15b into the hole portions 25 before the male terminals 13 and the cross-shaped slits (female terminals) 23 are fit to each other, the male terminals 13 and cross-shaped slits (female terminals) 23 can be roughly aligned. Accordingly, after the male terminals 13 and cross-shaped slits (female terminals) 23 are roughly aligned, the male and female connectors 10 and 20 can be joined to each other as the male terminals 13 and the cross-shaped slits (female terminals) 23 are being brought into contact with each other. Compared with the configuration in which the guide protrusions are fit to the hole portions from the beginning, the workability in joining the male and female connectors 10 and 20 can be improved.

In this embodiment, moreover, each hole portion 25 is composed of the substantially cross-shaped slit 25a, which is formed in the rear surface 21b of the male connector 20, and the insertion hole 25c, which communicates with the slit 25a and is larger in diameter than the guide protrusions 15. Accordingly, in the process of inserting the guide protrusions 15 into the hole portions 25, the guide protrusions 15 can be easily inserted into the centers of the slits 25a (hole portions 25) using the substantially cross-shaped slits 25a as a guide for positioning. Moreover, the configuration of the hole portions 25, which are large enough to allow the guide protrusions 15 to slightly move and position the columnar bumps 13 and cross-shaped slits 23, can be comparatively easily obtained.

In this embodiment, furthermore, by providing the ring-shaped opening 25b at the center of each substantially cross-shaped slit 25a, the elastically-deformable elastic pieces 25d protruding from the edge of the insertion hole 25c toward the center is formed. In other words, the hole portions 25 are configured to have the function of performing temporary positioning of the male and female connectors 10 and 20 and introducing the hole portions 25 to the respective positions where the neck portions 15a are inserted into the hole portions 25.

Accordingly, even if the guide protrusions 15 are inserted away from the centers of the slits 25a, the guide protrusions 15 can be guided to the centers of the slits 25a (hole portions 25) by the elastic force of the peripheral part (elastic pieces 25d). This can increase the accuracy of the relative positions of the guide protrusions 15 and hole portions 25 and therefore increase the accuracy of the relative positions of the male and female connectors 10 and 20.

Moreover, in each of the male terminals 13 of this embodiment, the diameter of the head portion (tip end portion) 13b is made smaller as a distance from the base substrate 11 of the male connector 10 increases. In this embodiment, since the diameter of the head portion (top portion) 13b is tapered in such a manner, in the event of inserting the male terminals 13 into the cross-shaped slits (male terminals) 23, the top surfaces of the head portions 13b serve as a guide to allow smooth insertion of the male terminals 13.

Still furthermore, each male terminal 13 of the embodiment is formed in a mushroom shape. Accordingly, the inserted mushroom-shaped head portions 13b can be caught on the pieces of the cross-shaped slits (female terminals) 23. It is therefore possible to prevent the male terminals 23 from being detached and therefore prevent the joined male and female connectors 10 and 20 from being separated from each other.

Still furthermore, this embodiment employs the two-step positioning structure which performs positioning by the neck and head portions 15a and 15b of the guide protrusions 15 protruded on the surface 11a side of the male connector 10. Accordingly, even if the head portions 15b formed on the neck portions 15a are slightly misaligned, such misalignment can be absorbed. The male connector 10 can be easily manufactured.

In this embodiment, by using the male connector 10 included in the connector assembly 1, the male connector 10 capable of improving the assembly workability of the connector assembly 1 can be obtained.

According to the method of manufacturing the male connector 10 of this embodiment, the plating process to form the male terminals 13 and the plating process to form the guide protrusions 15 can be simultaneously performed, thus simplifying the manufacturing process.

Hereinabove, the preferred embodiment of the present invention is described. However, the present invention is not limited to the aforementioned embodiment, and various modifications can be made.

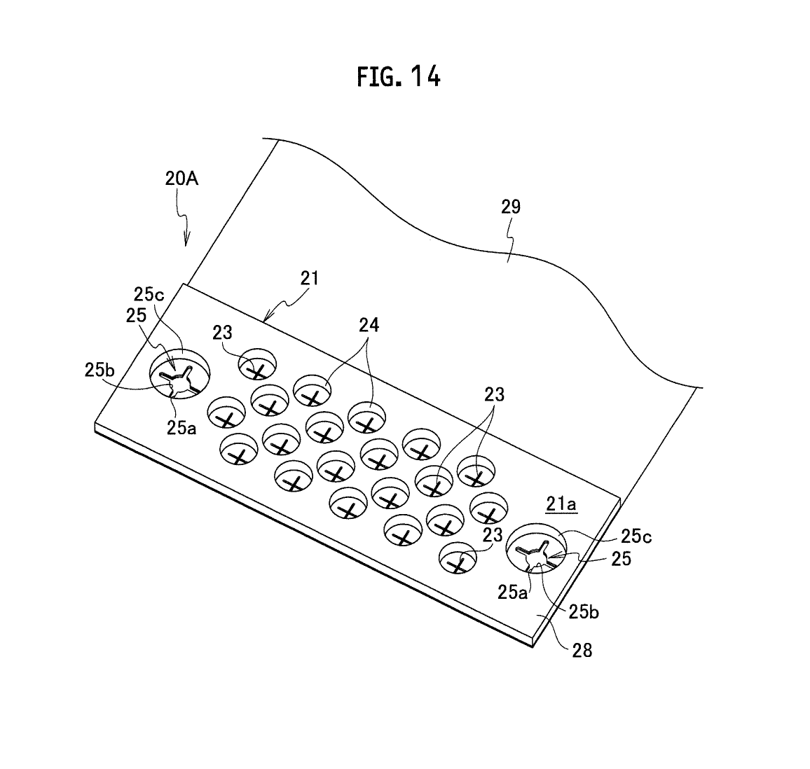

For example, as a modification shown in FIG. 14, the female connector of the connector assembly 1 used as an internal part of mobile phones can be a female connector 20A in which the flexible insulating film 29 and conductor lines 22 are extended in the width direction of the connector assembly 1.

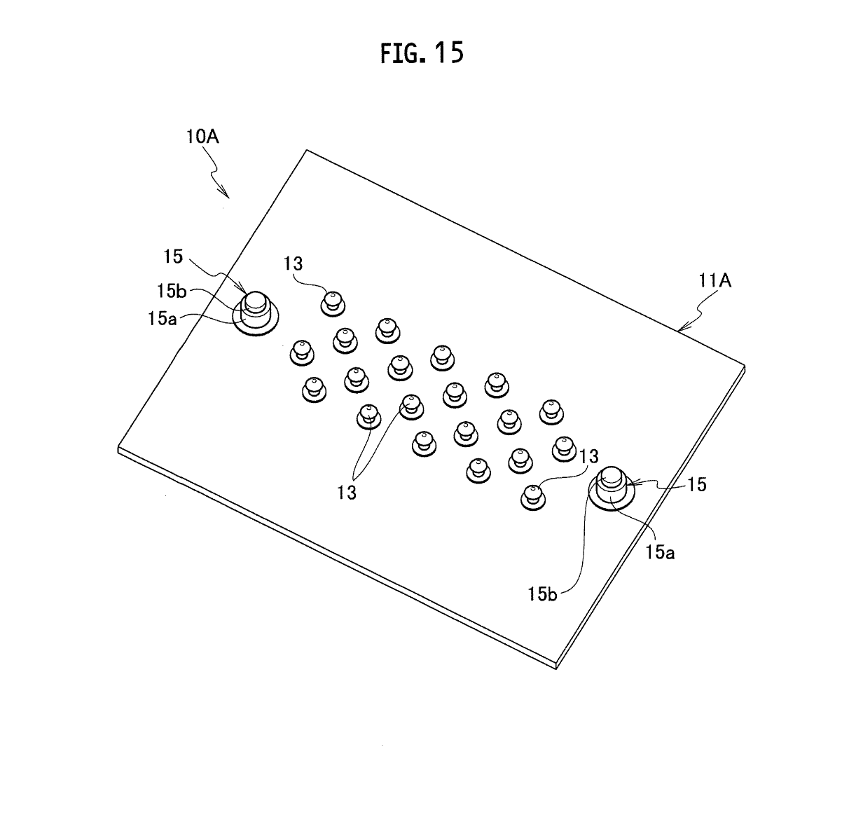

Moreover, as a modification shown in FIG. 15, the male connector of the connector assembly 1 can be a male connector 10A in which the male terminals 13 and guide protrusions 15 are directly formed in a mounting substrate 11A. The mounting substrate 11A corresponds to another circuit substrate or electronic part described in the above embodiment.

The connector assembly can be formed by using any one of the male connectors 10 and 10A and any one of the female connectors 20 and 20A.

What is claimed is:

1. A connector assembly, comprising: a male connector including a male terminal; and a female connector including a female terminal, the male and female connectors being joined to each other with the male and female terminals being brought into contact, wherein
a guide protrusion protruding higher than the male terminal is provided on one of facing surfaces of the male and female connectors,
a hole portion into which the guide protrusion is inserted to position the male and female terminals is provided for the other facing surface,
the guide protrusion includes: a positioning portion positioning the male and female terminals; and a temporary positioning portion which is provided on the positioning portion and has a diameter smaller than that of the positioning portion, and
the temporary positioning portion is inserted into the hole portion for temporary positioning of the male and female connectors before the positioning portion is inserted into the hole portion.

2. The connector assembly according to claim 1, wherein the hole portion has a function of being introduced to the position where the positioning portion is inserted into the hole portion and performing temporary positioning of the male and female connectors when the temporary positioning portion is inserted into the hole portion.

3. The connector assembly according to claim 1, wherein the male terminal is formed such that a diameter of a tip end portion thereof is made smaller as a distance from a base substrate of the male connector increases.

4. The connector assembly according to claim 1, wherein the male terminal has a mushroom shape.

5. A male connector used in the connector assembly according to claim 1.

6. A method of manufacturing a male connector which includes: a male terminal; and a guide protrusion protruding higher than the male terminal and including a positioning portion and a temporary positioning portion, the temporary positioning portion being formed on the positioning portion and having a smaller diameter than the positioning portion, the method comprising the steps of:
forming a first dry film resist layer on one of surfaces of a circuit substrate;
exposing and developing part of the first dry film resist layer to form a hole for forming the male terminal and a hole for forming the positioning portion of the guide protrusion;
forming a second dry film resist film to cover top part of the hole for forming the positioning portion;
exposing and developing part of the second dry film resist layer to form a hole for forming the temporary positioning portion of the guide protrusion and thereby forming a hole for forming the guide protrusion which is composed of the hole for forming the temporary positioning portion and the hole for forming the positioning portion; and
plating the hole for forming the male terminal and the hole for forming the guide protrusion to form the male terminal and guide protrusion.
